(19) United States
(12) Patent Application Publication
(10) Pub. No.: US 2016/0063906 A1
(43) Pub. Date: Mar. 3, 2016

(54) DRIVING CIRCUIT BOARD, DISPLAY MODULE AND AUTOMATIC TESTING METHOD OF DISPLAY PANEL

(71) Applicant: InnoLux Corporation, Jhu-Nan (TW)

(72) Inventor: Qi-Gong ZHAO, Jhu-Nan (TW)

(21) Appl. No.: 14/833,873

(22) Filed: Aug. 24, 2015

(30) Foreign Application Priority Data
Aug. 28, 2014 (TW) 103129735

(51) Int. Cl. G09G 3/00; G09G 3/32; G09G 3/36

(52) U.S. Cl. CPC G09G 3/006; G09G 3/3685; G09G 3/3275; G09G 2310/08; G09G 2330/12; G09G 2320/043

(57) ABSTRACT

A driving circuit board of a display panel includes a circuit board, a timing control circuit, a connector and a functional pin set. The timing control circuit is disposed on the circuit board. The connector is disposed on the circuit board. The functional pin set is disposed on the circuit board and has a ground pin and a function trigger pin. The function trigger pin is electrically connected to the timing control circuit. A display module and an automatic testing method of a display panel are also disclosed.

### CROSS REFERENCE TO RELATED APPLICATIONS

This Non-provisional application claims priority under 35 U.S.C. §119(a) on Patent Application No(s). 103129735 filed in Taiwan, Republic of China on Aug. 28, 2014, the entire contents of which are hereby incorporated by reference.

### BACKGROUND

1. Technical Field

The invention relates to a driving circuit board, a display module and an automatic testing method of display panel.

2. Related Art

After fabricated, the display module must pass several tests, for example aging test, in order to assemble at next stage. FIG. 1 is a schematic view showing the conventional display module under aging test. Referring to FIG. 1, a display module 1 includes a display panel 11 and a drive circuit board 12. The drive circuit board 12 is electrically connected to the display panel 11 to drive the display panel 11 to display a screen. In addition, the driving circuit board 12 has a timing control circuit 121 and a connector 122. The timing control circuit 121 is electrically connected to the data driving circuit (not shown) and the scan driving circuit (not shown) to send data signals, scan signals and other control signals to the data driving circuit and the scan driving circuit, thus driving the display panel 11 to display a screen.

In addition, for performing the aging test, the timing control circuit 121 has a built-in aging test mode (aging mode), as long as inputting a trigger signal, the timing control circuit 121 enters the aging test mode. For example, the display panel 11 is driven to display whole white, whole black, whole red, whole green and whole blue screens in sequence. In addition, the connector 122 at least requires a power pin, a trigger pin and a ground pin. Besides, a jig 10 together with a corresponding cable 101 is necessary to plug into the connector 122 to input a voltage power signal, a ground signal and a trigger signal respectively into the power pin, the ground pin and the trigger pin of the connector 122. Thus, the trigger signal is transmitted to the timing control circuit 121 so that the timing control circuit 121 enters the aging test mode.

However, the conventional technique has the following disadvantage.

First, staffs are required to prepare the corresponding cable 101 pursuant to the product type. Thus, it raises the manufacturing time and cost, and impacts on product introduction and production speed.

Second, the increased types and quantity of cables 101 are heavy burden on management. At test stations, staffs are particularly assigned to verify the matching state between the cable and the product, and assigned to sort and manage different cables.

Third, in addition to the lines corresponding to the power pin, the trigger pin and the ground pin, there are still numerous lines in the cable. When inserting the cable 101 into the connector 122, these lines may lead to electrostatic discharge (ESD) problem causing the product damage.

Fourth, more times staffs plug the connector 122, more possibly the cable 101 or the connector 122 suffer damage.

Fifth, the burden of product design is increased, so that it is necessary for the designer to reserve trigger pins of various product for receiving trigger signals.

In addition, the conventional technique is also unfavorable for the progress of automatic test. Therefore, it is an important subject to provide a driving circuit board, a display module and an automatic testing method of display panel which deal with the above problems and benefit automatic test.

### SUMMARY

An objective of some embodiments of the invention is to provide a driving circuit board, a display module and an automatic testing method of display panel which deal with the above problems, so as to reduce manufacturing time and raise product yield.

To achieve the above objective, a driving circuit board of a display panel, according to some embodiments of the invention includes a circuit board, a timing control circuit, a connector and a function pin set. The timing control circuit is disposed on the circuit board. The connector is disposed on the circuit board. The function pin set is disposed on the circuit board and has a ground pin and a function trigger pin. The function trigger pin is electrically connected to the timing control circuit.

In one embodiment, the function trigger pin receives a function trigger signal so as to trigger the timing control circuit to perform a testing function.

In one embodiment, the function trigger signal is sent to the timing control circuit to initialize the testing function.

In one embodiment, the function trigger pin is electrically connected to the timing control circuit via a converting circuit.

In one embodiment, the testing function is an aging test.

In one embodiment, the function pin set further includes a power pin for receiving a voltage power signal.

In one embodiment, the function pin set further includes another function trigger pin electrically connected to the timing control circuit.

In one embodiment, the function pin set has a connector structure.

In one embodiment, the function pin set has a structure of edge connector.

In one embodiment, the function pin set is located at a corner or an edge of the circuit board.

In one embodiment, the circuit board has a connecting structure adjacent to the function pin set.

In one embodiment, a pin interval of the function pin set is between 0.4 mm to 2.8 mm.

In one embodiment, a pin width of the function trigger pin is between 0.25 mm to 1.65 mm.

In one embodiment, the driving circuit board further includes a covering component covering the function pin set.

To achieve the above objective, a driving module according to some embodiments of the invention includes a display panel and a driving circuit board. The driving circuit board is electrically connected to the display panel, and it has a circuit board, a timing control circuit, a connector and a function pin set. The timing control circuit is disposed on the circuit board. The connector is disposed on the circuit board. The function pin set is disposed on the circuit board, and has a ground pin and a function trigger pin. The function trigger pin is electrically connected to the timing control circuit.

To achieve the above objective, an automatic testing method of a display panel according to some embodiments of the invention includes: providing a circuit board having a function pin set, wherein a timing control circuit is on the circuit board to drive the display panel, the function pin set has a ground pin and a function trigger pin, the function trigger pin is electrically connected to the timing control circuit; inputting a function trigger signal by one probe to the function trigger pin so as to trigger the timing control circuit to perform a function mode; and inputting a ground signal by another probe to the ground pin.

In one embodiment, the function mode is an aging test of the display panel.

In summary, as to the driving circuit board, the display module and the automatic testing method according to some embodiments of the invention, because the function pin set is disposed on the circuit board and the function trigger pin of the function pin set is electrically connected to the timing control circuit, the timing control circuit is triggered to perform the function mode such as testing function (for example aging test) when the function trigger pin receives the function trigger signal. Thus, it is not necessary for the staffs to prepare corresponding cables dependent on product type since all kinds of products utilize the same type cable. Therefore, it can deal with the above conventional problem, and benefits for the display module to be introduced with automatic test so as to reduce manufacturing time and raise product yield.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic diagram showing a conventional display module under aging test;

FIG. 2A is a schematic diagram showing a driving circuit board according to the first embodiment of the invention;

FIG. 2B is a schematic diagram showing the function pin set of the driving circuit board according to the first embodiment of the invention;

FIG. 3 is another schematic diagram showing a driving circuit board according to the first embodiment of the invention;

FIG. 4 is a schematic diagram showing a driving circuit board according to the second embodiment of the invention;

FIG. 5 is a schematic diagram showing a driving circuit board according to the third embodiment of the invention;

FIG. 6 is a schematic diagram showing a display module according to one embodiment of the invention; and

FIG. 7 is a flow chart showing an automatic testing method of display panel according to one embodiment of the invention.

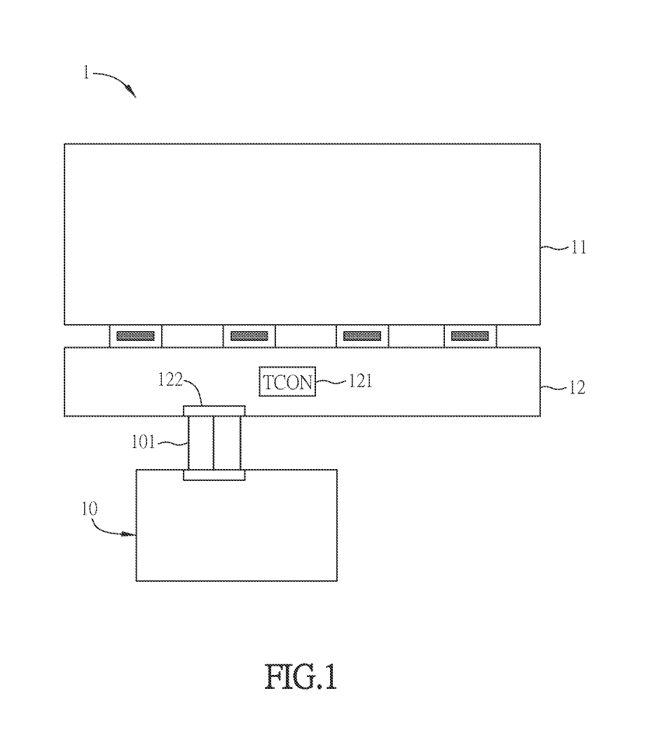

### DETAILED DESCRIPTION OF THE INVENTION

The driving circuit board, the display module and the automatic testing method of display panel according to the embodiments will be apparent from the following detailed description, which proceeds with reference to the accompanying drawings, wherein the same references relate to the same elements.

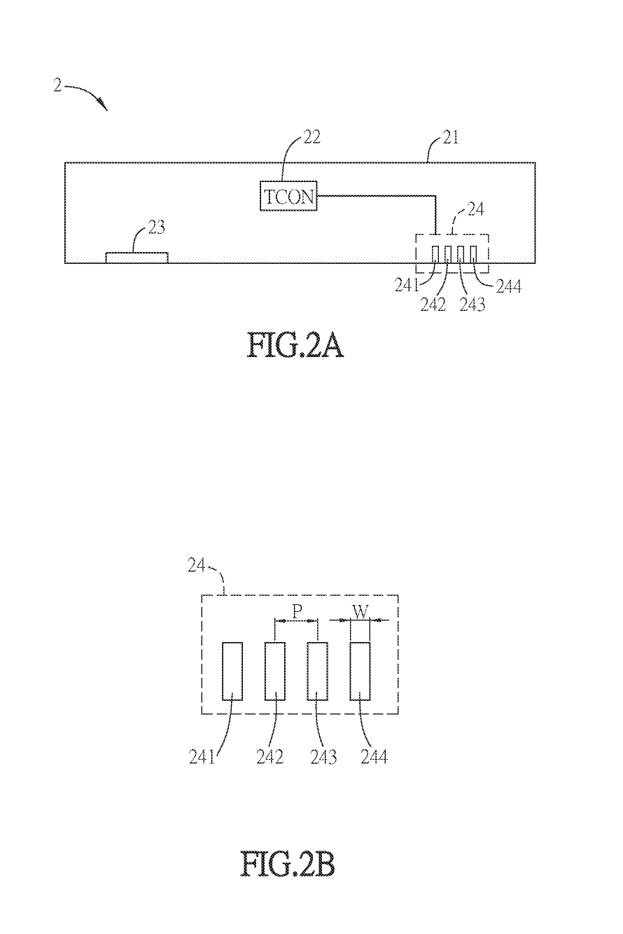

FIG. 2A is a schematic diagram showing a driving circuit board 2 according to the first embodiment of the invention. Referring to FIG. 2A, the driving circuit board 2 includes a circuit board 21, a timing control circuit 22, a connector 23 and a function pin set 24. In the embodiment, the driving circuit board 2 is a driving circuit board of a display panel. The display panel, for example, is an LCD (liquid crystal display) panel, an OLED (organic light emitting diode) display panel or other type display panel.

The timing control circuit 22 is disposed on the circuit board 21. The timing control circuit 22, for example, is a TCON (timing controller) which can be electrically connected to a data driving circuit and a scan driving circuit so as to drive the display panel to display a screen. The timing control circuit 22 can send data signals, scan signals and other control signals such as horizontal synchronization signal or vertical synchronization signal. In addition, the timing control circuit 22 can have a built-in function mode, as long as inputting a trigger signal, the timing control circuit 22 enters the corresponding function mode. For example, the function mode is an aging test mode in which the display panel is driven to display whole white, whole black, whole red, whole green and whole blue screens in sequence.

The connector 23 is disposed on the circuit board 21. In the embodiment, the interface standard of the connector 23 is not limited, and its actual type depends on the product on demand. Besides, the quantity of the connector 23 is also not limited in the embodiment.

The function pin set 24 is disposed on the circuit board 21, for example, it is located at a corner or an edge of the circuit board 21. The function pin set 24 includes a function trigger pin 241 and a ground pin 242. The function trigger pin 241 is electrically connected to the timing control circuit 22. In the embodiment, the function trigger pin 241 is directly electrically connected to the timing control circuit 22, namely, no other connecting element is connected with and between the two. Otherwise, in other embodiments, the function trigger pin 241 may be indirectly electrically connected to the timing control circuit 22. In addition, the ground pin 242 is electrically connected to the timing control circuit 22, too.

The function trigger pin 241 receives a function trigger signal. The function trigger signal is applied to trigger the timing control circuit 22 to perform a testing function. The function trigger signal can be provided by a jig. The testing function, for example, is an aging test. In the embodiment, the function trigger signal is directly sent to the timing control circuit 22 to initialize the testing function.

The ground pin 242 is configured to receive a ground signal. The function pin set 24 further includes a power pin 243 which receives a voltage power signal. The voltage power signal can be converted into appropriate voltage signal for supplied to the circuit board 21 for use. In the embodiment, the power pin 243 is also electrically connected to the timing control circuit 22. In addition, the function pin set 24 may further includes another function trigger pin 244 which is electrically connected to the timing control circuit 22. The function trigger pin 244 may be configured to receive another function trigger signal so as to make the timing control circuit 22 to enter another function mode.

The function pin set 24 can has an appropriate structure, for example, a connector structure or a structure of edge connector. Herein, the structure of edge connector is illustrated for example. Therefore, a plurality of probes controlled by a controller contact the pins of the function pin set 24 and then input signals, and the automatic test can be performed.

In addition, referring to FIG. 2B, a pin interval P (the distance between the two adjacent pins) of the function pin set 24 is between 0.4 mm to 2.8 mm. Thus, for example, the chances of inadvertent contacts between the probes and pins can be reduced. In addition, a pin width W of the function trigger pin 241 is between 0.25 mm to 1.65 mm. Thus, for example, the chances of inadvertent contacts between the probes and pins can be reduced, and to ensure that the probe is in well electrical contact with the pin.

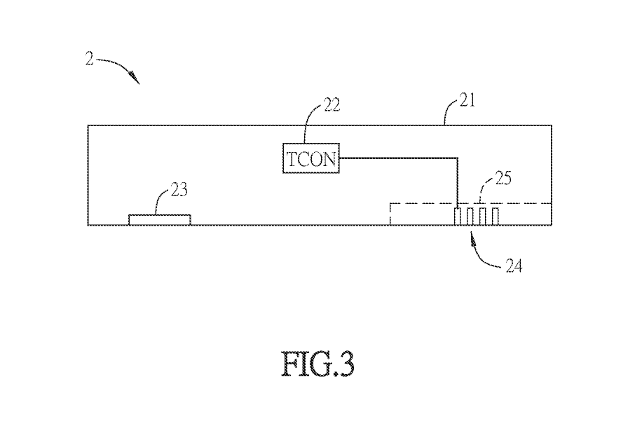

Referring to FIG. 3, in one embodiment, the driving circuit board 2 may further includes a covering component 25 which covers the function pin set 24. After test, the covering component 25 can be utilized to cover the function pin set 24 thus preventing staffs or users from inadvertent contacts that cause the product damaged. The covering component 25, for example, is adhesive tape.

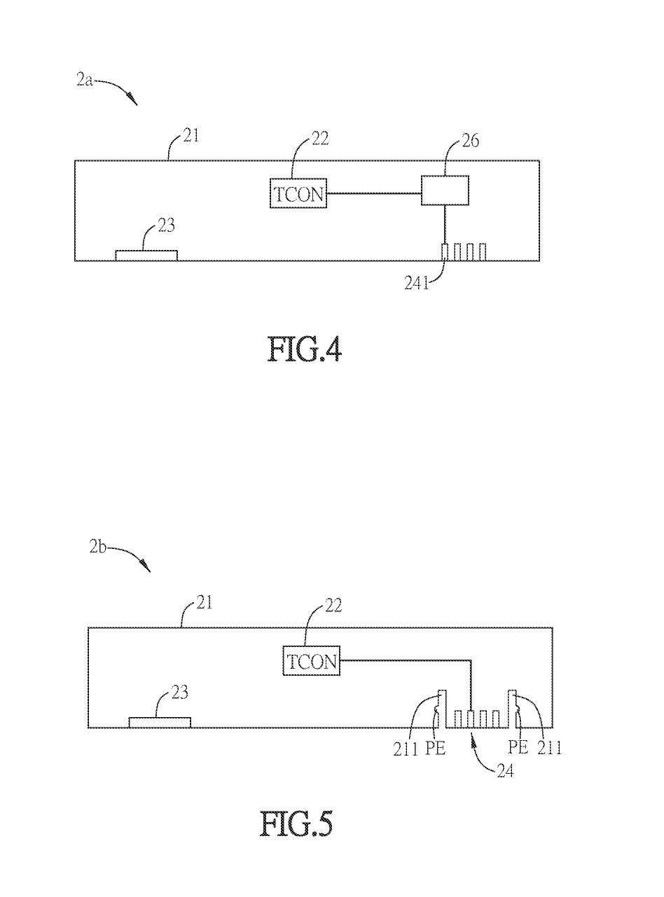

FIG. 4 is a schematic diagram showing a driving circuit board 2a according to the second embodiment of the invention. Referring to FIG. 4, the difference between the driving circuit boards 2a and 2 is that the function trigger pin 241 of the driving circuit board 2a is electrically connected to the timing control circuit 22 via a converting circuit 26. In the embodiment, the received function trigger signal by the function trigger pin 241 may not be sufficient to directly drive the timing control circuit 22 to enter a function mode, for example, its voltage is low but not high enough. It needs to be converted first by the converting circuit 26, for example raising its voltage, and then transmitted to the timing control circuit 22. In the embodiment, the conversion form of the converting circuit 26 is not limited, for example, it may include voltage, current or frequency conversion.

FIG. 5 is a schematic diagram showing a driving circuit board 2b according to the third embodiment of the invention. Referring to FIG. 5, the difference between the driving circuit boards 2b and 2 is that the circuit board 21 has a connecting structure 211 which is disposed adjacent to the function pin set 24. The connecting structure 211 may be connected to a signal input unit (not shown) so that the function pin set 24 receives an input signal from the signal input unit. The connecting structure 211, for example, is a concave-convex structure (e.g. plenty of indentations), and the signal input unit is wedged to the connecting structure 211 so as to be electrically connected to the function pin set 24. In addition, the connecting structure 211 includes at least one position element PE. Herein, the position PE is a pit for example. The signal input unit may be positioned by the position PE.

It is noted that the technique features of the above embodiments can be utilized singly or combined with each other.

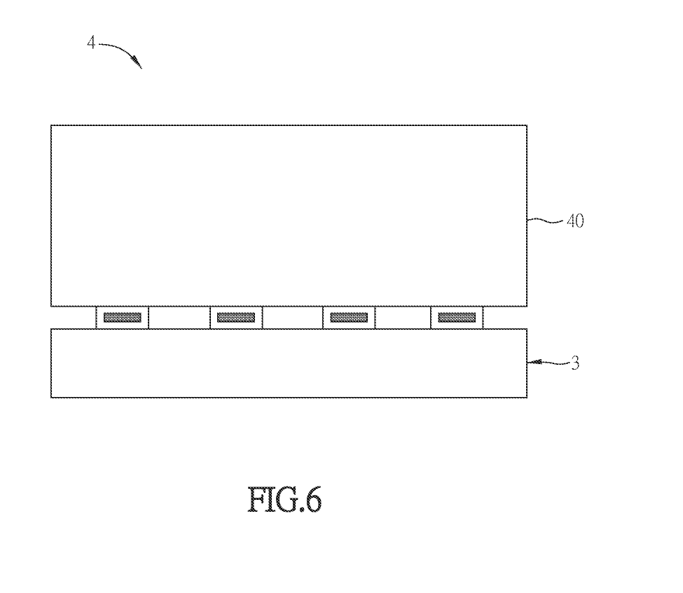

FIG. 6 is a schematic diagram showing a display module 4 according to one embodiment of the invention. Referring to FIG. 6, the display module 4 includes a display panel 40 and a driving circuit board 3. The display panel 40, for example, is an LCD panel, an LED display panel or other type display panel. The driving circuit board 3 may be one the above mentioned driving circuit board 2, 2a and 2b or their combination. The driving circuit board 3 is electrically connected to the display panel 40 so as to drive the display panel 40 to display a screen. Because technique features of the driving circuit board 3 can be referred to that of the above embodiments, they are not repeated here.

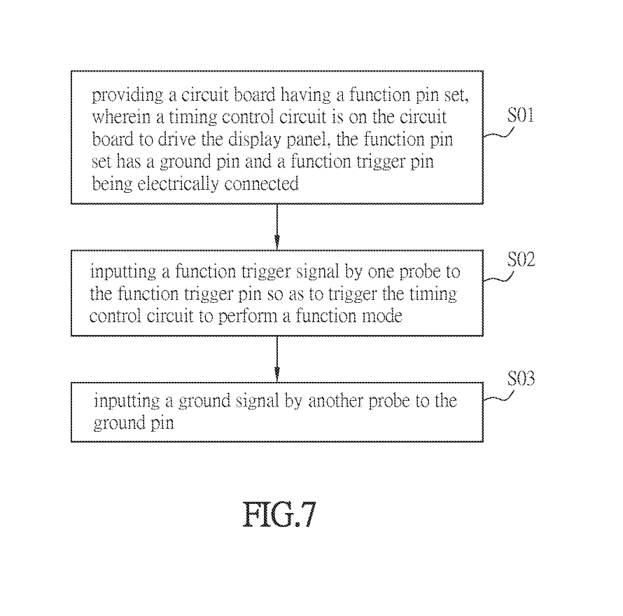

FIG. 7 is a flow chart showing an automatic testing method of display panel according to one embodiment of the invention. The automatic testing method can be applied to appropriate display panel, for example, an LCD panel, an OLED display panel or other type display panel. The automatic testing method includes the steps of: providing a circuit board having a function pin set, wherein a timing control circuit is on the circuit board to drive the display panel, the function pin set has a ground pin and a function trigger pin, the function trigger pin is electrically connected to the timing control circuit (step S01); inputting a function trigger signal by one probe to the function trigger pin so as to trigger the timing control circuit to perform a function mode (step S02); and inputting a ground signal by another probe to the ground pin (step S03). The function mode, for example, is an aging test of the display panel.

Because technique features of the automatic testing method are also illustrated on the above embodiments, they are not repeated here. It is noted that, because the automatic testing method in the embodiment utilizes probes to input the function trigger signal, ground signal and/or other signals, the automatic test is achieved so as to raise manufacturing speed and product yield.

In summary, as to the driving circuit board, the display module and the automatic testing method of display panel according to the invention, because the function pin set is disposed on the circuit board and the function trigger pin of the function pin set is electrically connected to the timing control circuit, the timing control circuit is triggered to perform the function mode such as testing function (for example aging test) when the function trigger pin receives the function trigger signal. Thus, it is not necessary for the staffs to prepare corresponding cables dependent on product type since all kinds of products utilize the same type cable. Therefore, it can deal with the above conventional problem, and benefits for the display module to be introduced with automatic test so as to reduce manufacturing time and raise product yield.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A driving circuit board of a display panel, comprising:
a circuit board;
a timing control circuit, disposed on the circuit board;
a connector, disposed on the circuit board; and
a function pin set, disposed on the circuit board and having a ground pin and a function trigger pin being electrically connected to the timing control circuit.

2. The driving circuit board of claim 1, wherein the function trigger pin receives a function trigger signal so as to trigger the timing control circuit to perform a testing function.

3. The driving circuit board of claim 1, wherein the function pin set further comprises a power pin for receiving a voltage power signal.

4. The driving circuit board of claim 1, wherein the function pin set has a connector structure.

5. The driving circuit board of claim 1, wherein the function pin set has a structure of edge connector.

6. The driving circuit board of claim 1, wherein a pin interval of the function pin set is between 0.4 mm to 2.8 mm.

7. The driving circuit board of claim 1, wherein a pin width of the function trigger pin is between 0.25 mm to 1.65 mm.

8. The driving circuit board of claim 1, further comprising:
a covering component, covering the function pin set.

9. A display module, comprising:
a display panel; and
a driving circuit board, electrically connected to the display panel and having:
a circuit board;
a timing control circuit, disposed on the circuit board;
a connector, disposed on the circuit board; and
a function pin set, disposed on the circuit board and having a ground pin and a function trigger pin being electrically connected to the timing control circuit.

10. An automatic testing method of a display panel, comprising:
providing a circuit board having a function pin set, wherein a timing control circuit is on the circuit board to drive the display panel, the function pin set has a ground pin and a function trigger pin being electrically connected to the timing control circuit;
inputting a function trigger signal by one probe to the function trigger pin so as to trigger the timing control circuit to perform a function mode; and
inputting a ground signal by another probe to the ground pin.
